(19) United States
(12) Patent Application Publication
(10) Pub. No.: US 2022/0340478 A1
(43) Pub. Date: Oct. 27, 2022

(54) COLOR STABILITY UNDER IRRADIATION WITH BLUE LIGHT

(71) Applicant: Schott AG, Mainz (DE)

(72) Inventors: Ralf Jedamzik, Griesheim (DE); Antoine Carré, Mainz (DE); Sebastian Leukel, Mainz (DE); Volker Hagemann, Nieder-Olm (DE); Uwe Petzold, Osthofen (DE); Lothar Bartelmess, Klein-Winternheim (DE)

(73) Assignee: Schott AG, Mainz (DE)

(21) Appl. No.: 17/730,700

(22) Filed: Apr. 27, 2022

(30) Foreign Application Priority Data
Apr. 27, 2021 (DE) 10 2021 110 793.8
May 28, 2021 (TW) 110119452
Nov. 26, 2021 (DE) 10 2021 131 152.7

(51) Int. Cl. C03C 3/091; H04N 9/31; C03C 4/08

(52) U.S. Cl. CPC C03C 3/091; H04N 9/3152; C03C 4/085; C03C 2201/50; C03C 2201/32; C03C 2201/10

(57) ABSTRACT

A glass includes the following components in the specified proportions (in % by weight): 50-80% SiO₂, 2-30% B₂O₃, 0-5% Al₂O₃, 0-10% CaO, 0-10% BaO, 0-5% Li₂O, 0-20% Na₂O, 1-25% K₂O, and 5-30% ΣR₂O. R₂O includes at least one alkali metal oxide. The glass includes at least one first solarization component and at least one second solarization component. A proportion of the first solarization component in the glass is in a range from 0.01 to <1.0 ppm (by weight) and a proportion of the second solarization component in the glass is in a range from 1000 to 10,000 ppm (by weight).

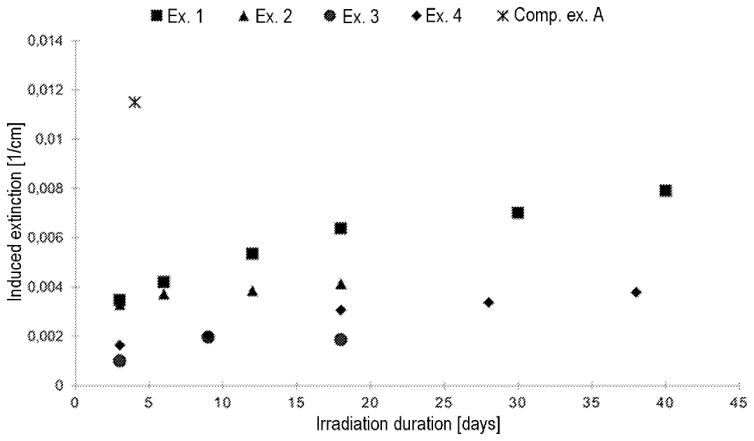

### CROSS REFERENCE TO RELATED APPLICATIONS

This application claims priority to German Patent Application No. DE 10 2021 131 152.7 filed on Nov. 26, 2021, which is incorporated in its entirety herein by reference. This application also claims priority to Taiwanese Patent Application No. TW 110119452 filed on May 28, 2021, which is incorporated in its entirety herein by reference. This application also claims priority to German Patent Application No. DE 10 2021 110 793.8 filed on Apr. 27, 2021, which is incorporated in its entirety herein by reference.

### BACKGROUND OF THE INVENTION

### 1. Field of the Invention

The present invention relates to a glass with high color stability at high beam power densities and the use thereof, in particular in or as a beam guiding element in an imaging system, for example in projectors and in material processing.

### 2. Description of the Related Art

Light sources for projectors are currently transitioning from xenon to laser illuminants and pure RGB laser sources with constantly increasing luminous fluxes and power densities. Present-day cinema projectors comprising laser sources achieve for example a luminous flux of up to 75,000 lumens and surface power densities of up to 50 W/cm² or more. Increasing luminous fluxes and power densities can lead to solarization effects which adversely affect color stability.

The optical system of a cinema projector typically consists of a larger volume prism arrangement and a projection objective. Especially the prism arrangement is exposed to high power densities. The demands on optical glasses are therefore ever increasing.

Traditional xenon-based cinema projectors have maximum luminous fluxes of up to 45,000 lumens. However, modern laser-based projectors achieve luminous fluxes of up to 75,000 lumens and surface power densities of up to 50 W/cm² or more. A powerful blue laser stimulates emission of yellow light in a converter. The green and yellow channels are extracted from the yellow light using dichroic filters. A portion of the blue light is employed for the blue channel. All three channels are then used for projection.

The projection system often consists of a complex prism arrangement to guide the individual color channels to the DLP chips and to mix the signals for image formation. The optical path length may be greater than 100 to 200 mm. Any light absorption within the present arrangement results in temperature gradients and thermal lens effects. The prism glass should therefore have the highest possible transmission in the visible wavelength range. Further effects becoming increasingly important with the increasing luminous fluxes of the projectors are solarization effects in the glass. Absorption-induced generation of absorbtive components in the prism glass can result in wavelength-dependent reduction in transmission which is in turn associated with an altered color spectrum since the species generated do not absorb homogeneously over the entire spectrum but rather can exhibit absorption maxima in certain ranges.

What is needed in the art is a way to provide imaging systems comprising beam guiding elements which exhibit high color stability and are therefore suitable for use in projectors but also in applications in material processing.

### SUMMARY OF THE INVENTION

In some exemplary embodiments provided according to the present invention, a glass includes the following components in the specified proportions (in % by weight): 50-80% SiO₂, 2-30% B₂O₃, 0-5% Al₂O₃, 0-10% CaO, 0-10% BaO, 0-5% Li₂O, 0-20% Na₂O, 1-25% K₂O, and 5-30% ΣR₂O. R₂O includes at least one alkali metal oxide. The glass includes at least one first solarization component and at least one second solarization component. A proportion of the first solarization component in the glass is in a range from 0.01 to <1.0 ppm (by weight) and a proportion of the second solarization component in the glass is in a range from 1000 to 10,000 ppm (by weight).

In some exemplary embodiments provided according to the present invention, a beam guiding element includes or consists of a glass. The glass includes the following components in the specified proportions (in % by weight): 50-80% SiO₂, 2-30% B₂O₃, 0-5% Al₂O₃, 0-10% CaO, 0-10% BaO, 0-5% Li₂O, 0-20% Na₂O, 1-25% K₂O, and 5-30% ΣR₂O. R₂O includes at least one alkali metal oxide. The glass includes at least one first solarization component and at least one second solarization component. A proportion of the first solarization component in the glass is in a range from 0.01 to <1.0 ppm (by weight) and a proportion of the second solarization component in the glass is in a range from 1000 to 10,000 ppm (by weight).

In some exemplary embodiments provided according to the present invention, an imaging system includes at least one laser light source having a wavelength in a spectral range from 380 nm to 490 nm and a beam guiding element. The beam guiding element includes or consists of a glass. The glass includes the following components in the specified proportions (in % by weight): 50-80% SiO₂, 2-30% B₂O₃, 0-5% Al₂O₃, 0-10% CaO, 0-10% BaO, 0-5% Li₂O, 0-20% Na₂O, 1-25% K₂O, and 5-30% ΣR₂O. R₂O includes at least one alkali metal oxide. The glass includes at least one first solarization component and at least one second solarization component. A proportion of the first solarization component in the glass is in a range from 0.01 to <1.0 ppm (by weight) and a proportion of the second solarization component in the glass is in a range from 1000 to 10,000 ppm (by weight). The at least one laser light source is suitable for generating at at least one point of the beam guiding element an average surface power density of more than 10 W/cm².

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

the sole figure shows the induced induction as a function of irradiation duration for the example glasses 1 to 4 and for comparative example A.

The exemplifications set out herein illustrate embodiments of the invention and such exemplifications are not to be construed as limiting the scope of the invention in any manner.

### DETAILED DESCRIPTION OF THE INVENTION

In some exemplary embodiments provided according to the present invention, a glass comprises the following components in the specified proportions (in % by weight)

| | from | to |
|---|---|---|
| SiO₂ | 50 | 80 |
| B₂O₃ | 2 | 30 |
| Al₂O₃ | 0 | 5 |
| CaO | 0 | 10 |
| BaO | 0 | 10 |
| Li₂O | 0 | 5 |
| Na₂O | 0 | 20 |
| K₂O | 1 | 25 |
| Σ R₂O | 5 | 30 |

wherein the glass comprises at least one first solarization component and at least one second solarization component, wherein the proportion of the first solarization component in the glass is in a range from 0.01 to <1.0 ppm (by weight) and wherein the proportion of the second solarization component in the glass is in the range from 1000 to 10,000 ppm (by weight).

The glass provided according to the invention comprises a first and a second solarization component. The first solarization component is a component which even when selecting particularly pure raw materials cannot be 100% avoided and which even in very small proportions at correspondingly high power densities especially comprising light in the blue spectral range results in solarization effects associated with absorption of certain wavelengths within the visible spectrum. Since the absorption is not uniformly distributed over the entire visible spectrum, but rather absorption occurs more strongly at particular wavelengths than at other wavelengths, this results in unwanted color deviations.

The first absorption component may, for example, comprise MnO₂ or be MnO₂. Raw materials for glass production are contaminated with MnO₂. It is therefore not possible to provide a glass that does not contain MnO₂. However, contamination with MnO₂ can be reduced through selection of the raw materials. Commercial raw materials afford glasses having a proportion of MnO₂ which is in any event more than 1.0 ppm. Selection of particularly pure raw materials makes it possible to reduce the proportion of MnO₂ to values of less than 1.0 ppm. In the present disclosure the term “MnO₂” is to be understood as meaning a collective term for all manganese oxide species unless otherwise stated. Mn may in particular be present in different oxidation states.

Photooxidation can in particular convert Mn²⁺ into the absorptive component Mn³⁺ which is particularly absorptive in the yellow spectral range at wavelengths of 560 nm to 590 nm, in particular at about 580 nm. By contrast, the absorption of Mn³⁺ exhibits a minimum in the blue spectral range at wavelengths of 450 nm to 475 nm. The irradiation-dependent formation of Mn³⁺ from the first solarization component therefore results in a shift in the spectral absorption properties of the glass.

Since the first solarization component cannot be completely avoided, the invention provides for a second solarization component to counteract the shift in spectral properties. This is associated with a higher overall solarization. However, this may be acceptable from the point of view of improving the spectral uniformity of the absorption.

The second solarization component should be selected such that the absorptive species formed therefrom as a function of irradiation should be as complementary as possible in terms of absorption characteristics to the absorption of the species formed from the first solarization component. Especially in the case of MnO₂ as the first solarization component it may be advantageous, for example, when the absorptive species formed from the second solarization component has/have a greater absorption at wavelengths of 450 nm to 475 nm than at wavelengths of 560 to 590 nm.

The first absorption component results in the disruptive absorption even in extremely small amounts. Such small amounts result from impurities and can be adjusted only with difficulty through specific addition of the first solarization component. Addition of the first solarization component should also be avoided in light of the strong solarization properties. It is advantageous to keep the proportion of the first solarization component low.

Selection of particularly pure raw materials makes it possible to reduce the proportion of the first solarization component to values of less than 1.0 ppm. The proportion of the first solarization component may be at most 0.9 ppm, at most 0.8 ppm, at most 0.7 ppm, at most 0.6 ppm, at most 0.5 ppm, at most 0.4 ppm, at most 0.3 ppm, at most 0.2 ppm, at most 0.15 ppm, or at most 0.1 ppm. In some embodiments, the proportion of the first solarization component is at least 0.01 ppm, at least 0.02 ppm or at least 0.05 ppm. The proportion of the first solarization component may be, for example, in a range from 0.01 to <1.0 ppm, from 0.01 to 0.9 ppm, from 0.01 to 0.8 ppm, from 0.01 to 0.7 ppm, from 0.01 to 0.6 ppm, from 0.01 to 0.5 ppm, from 0.01 to 0.4 ppm, from 0.01 to 0.3 ppm, from 0.01 to 0.2 ppm, from 0.01 to 0.15 ppm, from 0.01 to 0.1 ppm, from 0.02 to <1.0 ppm, from 0.02 to 0.9 ppm, from 0.02 to 0.8 ppm, from 0.02 to 0.7 ppm, from 0.02 to 0.6 ppm, from 0.02 to 0.5 ppm, from 0.02 to 0.4 ppm, from 0.02 to 0.3 ppm, from 0.02 to 0.2 ppm, from 0.02 to 0.15 ppm, from 0.02 to 0.1 ppm, from 0.05 to <1.0 ppm, from 0.05 to 0.9 ppm, from 0.05 to 0.8 ppm, from 0.05 to 0.7 ppm, from 0.05 to 0.6 ppm, from 0.05 to 0.5 ppm, from 0.05 to 0.4 ppm, from 0.05 to 0.3 ppm, from 0.05 to 0.2 ppm, from 0.05 to 0.15 ppm, or from 0.05 to 0.1 ppm.

By contrast, the second absorption component shall be specifically added to equalize the absorption effects deriving from the first solarization component at other wavelengths. It is therefore advantageous when the solarization effects for the second solarization component based on the proportion thereof are less pronounced than for the first solarization component, so that relatively larger amounts of the second solarization component may be added to achieve the desired equalizing effect. Addition of relatively larger amounts makes it possible to adjust the amount and thus also the effect of greater precision.

The proportion of the second solarization component may be at least 0.1% by weight, at least 0.15% by weight, at least 0.2% by weight, at least 0.25% by weight, at least 0.3% by weight, at least 0.35% by weight, or at least 0.4% by weight. In some embodiments, the proportion of the second solarization component is at most 1.0% by weight or at most 0.5% by weight. The proportion of the second solarization component may be, for example, in the range from 0.1% to 1.0% by weight. The proportion of the second solarization component may be at most 1.0% by weight, for example at most 0.75% by weight, at most 0.5% by weight or at most 0.45% by weight.

The solarization properties of the second solarization component may in particular have as their basis that appropriately high beam power densities, in particular with light in the blue spectral range, lead to a photoreduction which forms absorptive species. In the case of a metal oxide M^{I}O₂ as the second solarization component a reduction of M^{I4+} to M^{I2+} for example may occur. In the case of a metal oxide M^{II}₂O₃ as the second solarization component a photoreduction of M^{II5+} to M^{II3+} for example may occur.

A photoreduction occurs all the more easily, the greater (positive/less negative) the standard redox potential E⁰ of the redox pair involved. The proportion of the second solarization component may therefore be adapted according to the standard redox potential of the redox pair upon which the solarization is based. In the case of a high standard redox potential, it may be advantageous to apply a stricter upper limit to the proportion of the second solarization component since the photoreduction tends to be more pronounced and a relatively larger proportion of the absorptive species is thus formed from the second solarization component.

In this regard, it should also be noted that depending on the type of the second solarization component different molar proportions of the species involved in the redox reactions can occur. For example, one mol of metal oxide M^{I}O₂ as the second solarization component provides 1 mol of M^{I} while one mol of metal oxide M^{II}₂O₃ as the second solarization component provides two mol of M^{II}. It may therefore be advantageous when adapting the proportion of the second solarization component according to the standard redox potential to give the first metal oxide M^{I}O₂ a weighting of one while giving the molar proportion of the second metal oxide M^{II}₂O₃ a weighting of two.

The product of the (average) standard redox potential E⁰ of the second solarization component and the sum of the molar proportion of the first metal oxide M^{I}O₂ and twice the molar proportion of the second metal oxide M^{II}₂O₃ in the glass may be, for example, at most −100 V*ppm, at most −200 V*ppm, at most −300 V*ppm, at most −400 V*ppm, at most −500 V*ppm, at most −600 V*ppm, at most −700 V*ppm, at most −800 V*ppm, at most −900 V*ppm, at most −1000 V*ppm, or at most −1100 V*ppm. The product of the (average) standard redox potential E⁰ of the second solarization component and the sum of the molar proportion of the first metal oxide M^{I}O₂ and twice the molar proportion of the second metal oxide M^{II}₂O₃ in the glass may be, for example, at least −2200 V*ppm, at least −2100 V*ppm, at least −2000 V*ppm, at least −1900 V*ppm, at least −1800 V*ppm, at least −1700 V*ppm, at least −1600 V*ppm, at least −1500 V*ppm, at least −1400 V*ppm, at least −1300 V*ppm, or at least −1200 V*ppm. The product of the (average) standard redox potential E⁰ of the second solarization component and the sum of the molar proportion of the first metal oxide M^{I}O₂ and twice the molar proportion of the second metal oxide M^{II}₂O₃ in the glass may be, for example, in a range from −2200 to −100 V*ppm, from −2100 to −200 V*ppm, from −2000 to −300 V*ppm, from −1900 to −400 V*ppm, from −1800 to −500 V*ppm, from −1700 to −600 V*ppm, from −1600 to −700 V*ppm, from −1500 to −800 V*ppm, from −1400 to −900 V*ppm, from −1300 to −1000 V*ppm, or from −1200 to −1100 V*ppm.

The standard redox potential is the reduction/oxidation standard potential measured under standard conditions against a standard reference hydrogen half-cell. The standard redox potential may be determined in particular according to DIN 38404-6. The present disclosure relates to the standard redox potential at a pH of 14.

The second solarization component may in particular also comprise a first metal oxide M^{I}O₂ and a second metal oxide M^{II}₂O₃. The redox pairs respectively involved in the solarization will regularly exhibit different standard redox potentials. Having regard to the standard redox potential of the second solarization component the average standard redox potential can especially be taken into account. The average standard redox potential E⁰ of the second solarization component is in particular the average of the proportionally weighted standard redox potential of the redox pair M^{I2+}/M^{I4+} and the proportionally weighted standard redox potential of the redox pair M^{II3+}/M^{II5+}, wherein the proportionally weighted standard redox potential of the redox pair M^{I2+}/M^{I4+} is the product of the standard redox potential of the redox pair M^{I2+}/M^{I4+} and the molar proportion of the first metal oxide M^{I}O₂ in the second solarization component and wherein the proportionally weighted standard redox potential of the redox pair M^{II3+}/M^{II5+} is the product of the standard redox potential of the redox pair M^{II3+}/M^{II5+} and twice the molar proportion of the second metal oxide M^{II}₂O₃ in the second solarization component.

The average standard redox potential E⁰ of the second solarization component may be, for example, at most −50 mV, at most −150 mV, at most −250 mV, at most −350 mV, at most −450 mV, at most −550 mV, at most −650 mV, at most −750 mV or at most −850 mV. The average standard redox potential E⁰ of the second solarization component may be, for example, at least −1750 mV, at least −1650 mV, at least −1550 mV, at least −1450 mV, at least −1350 mV, at least −1250 mV, at least −1150 mV, at least −1050 mV or at least −950 mV. The average standard redox potential E⁰ of the second solarization component may be, for example, in a range from −1750 mV to −50 mV, from −1650 mV to −150 mV, from −1550 mV to −250 mV, from −1450 mV to −350 mV, from −1350 mV to −450 mV, from −1250 mV to −550 mV, from −1150 mV to −650 mV, from −1050 mV to −750 mV or from −950 mV to −850 mV.

Having regard to the reduced tendency for photo reduction a low standard redox potential allows for the use of relatively large amounts of the second solarization component while solarization remains constant, thus simplifying establishment of the desired spectral absorption supplementing the absorption deriving from the first solarization component.

The proportion of the second solarization component may in particular also be adapted to the proportion of the first solarization component. At particularly low proportions of the first solarization component, a correspondingly low proportion of the second solarization component may already be sufficient to achieve the desired equalization of the spectral properties. By contrast, if a relatively large amount of the first solarization component is present it may be advantageous to select a correspondingly larger proportion of the second solarization component. The weight ratio of the proportion of the second solarization component to the proportion of the first solarization component may be, for example, in a range from 2000:1 to 100,000:1, in particular in a range from 2500:1 to 75,000:1, from 3000:1 to 50,000:1, from 3500:1 to 45,000:1 or from 4000:1 to 40,000:1. The weight ratio of the proportion of the second solarization component to the proportion of the first solarization component may be, for example, at least 2000:1, at least 2500:1, at least 3000:1, at least 3500:1 or at least 4000:1. The weight ratio of the proportion of the second solarization component to the proportion of the first solarization component may be, for example, at most 100,000:1, at most 75,000:1, at most 50,000:1, at most 45,000:1 or at most 40,000:1.

The proportion of the second solarization component may be further limited by taking into account the (average) standard redox potential E⁰ of the second solarization component. It may especially be advantageous at low standard redox potential to select a correspondingly larger excess of second solarization component over the proportion of the first solarization component than in the case of a relatively large standard redox potential of the second solarization component. The product of the average standard redox potential E⁰ of the second solarization component and the molar ratio of the proportion of the second solarization component to the proportion of the first solarization component may be, for example, at most −5000 V, at most −7500 V, at most −10,000 V, at most −12,500 V or at most −15,000 V. The product of the average standard redox potential E⁰ of the second solarization component and the molar ratio of the proportion of the second solarization component to the proportion of the first solarization component may be, for example, at least −27,500 V, at least −25,000 V, at least −22,500 V, at least −20,000 V or at least −17,500 V. The product of the average standard redox potential E⁰ of the second solarization component and the molar ratio of the proportion of the second solarization component to the proportion of the first solarization component may be, for example, in a range from −27,500 to −5000 V, from −25,000 to −7500 V, from −22,500 to −10,000 V, from −20,000 to −12,500 V or from −17,500 to −15,000 V.

The second solarization component may, for example, be selected from the group consisting of SnO₂, Sb₂O₃ and combinations thereof. These components result in absorption complementary to the absorption of the first solarization component. In some embodiments, the second solarization component is SnO₂. The proportion of Sb₂O₃ in the glass may be, for example, less than 500 ppm, less than 300 ppm, less than 100 ppm, less than 50 ppm or less than 10 ppm, in each case by weight. The glass may be free from Sb₂O₃.

The glass provided according to the invention especially exhibits exceptional long-term solarization stability. In particular, the additional extinction Ext₁(436 nm) relative to Ext₀(436 nm) at a wavelength of 436 nm of a sample having a thickness of 100 mm after irradiation at a power density of 345 W/cm² for 40 days with laser light having a wavelength of 455 nm is at least 0.0001/cm and/or at most 0.01/cm, wherein Ext₀(436 nm) is the extinction at a wavelength of 436 nm of a sample having a thickness of 100 mm without corresponding irradiation. The additional extinction Ext₁(546 nm) relative to Ext₀(546 nm) at a wavelength of 546 nm of a sample having a thickness of 100 mm after irradiation at a power density of 345 W/cm² for 40 days with laser light having a wavelength of 455 nm may be, for example, at least 0.0001/cm and/or at most 0.01/cm, wherein Ext₀(546 nm) is the extinction at a wavelength of 546 nm of a sample having a thickness of 100 mm without corresponding irradiation. The additional extinction Ext₁(644 nm) relative to Ext₀(644 nm) at a wavelength of 644 nm of a sample having a thickness of 100 mm after irradiation at a power density of 345 W/cm² for 40 days with laser light having a wavelength of 455 nm may be, for example, at least 0.0001/cm and/or at most 0.01/cm, wherein Ext₀(644 nm) is the extinction at a wavelength of 644 nm of a sample having a thickness of 100 mm without corresponding irradiation. Ext₁(436 nm), Ext₁(546 nm) and/or Ext₁(644 nm) may be, for example, in a range from 0.0001/cm to 0.01/cm, from 0.0002 to 0.009/cm or from 0.0004/cm to 0.008/cm. Ext₁(436 nm), Ext₁(546 nm) and/or Ext₁(644 nm) are, for example, at least 0.0001/cm, 0.0002/cm or at least 0.0004/cm. Ext₁(436 nm), Ext₁(546 nm) and/or Ext₁(644 nm) are, for example, at most 0.01/cm, at most 0.009/cm or at most 0.008/cm.

The color impression may be described on the basis of the CIE 1931 color space which represents a color impression through a combination of three values, namely the x-value, the y-value and the z-value (color coordinates). It may bey determined according to DIN 5033 using light type “C” at 6770 K for the CIE standard observer within a 2° arc around the fovea (CIE 1931 2° standard observer). In short X, Y, and Z standard spectral values are taken from the table of the CIE 1931 color space system and multiplied by the measured transmission values to obtain the corresponding tristimulus values.

The color coordinates x, y and z, which define the color point or the color position within the color space are obtained by normalizing the sum of x+y+z to 1. The x-value, y-value and z-value are thus positive values and the sum of x+y+z=1. The CIE color space palette 1931 represents the color space, wherein the x-axis relates to the x-values and the y-axis relates to the y-values. The z-value may be derived from any pair of x- and y-values by calculating z=1−x−y. The point x=y=z=⅓ represents the so-called “white point” which defines the color white. High x-values represent reddish colors. High y-values represent greenish colors. High z-values represent bluish colors. Any color type is represented as a particular color point in the color space. Additive combination colors have their color point on the the straight connecting line between the components. For exact characterization of the color stimulus specification the tricolor value Y is used as a lightness reference value (DIN 5033, part 1) by dividing the sum of all y-values by a ratio (=21.293658). The resulting value is normalized to a maximum of 100. This value indicates whether the glass is lighter or darker to the human eye relative to a reference sample.

The x-value, y-value and z-value are positive values and the sum of x+y+z=1. The CIE color space palette 1931 represents the color space, wherein the x-axis relates to the x-values and the y-axis relates to the y-values. The z-value may be derived from any pair of x- and y-values by calculating z=1−x−y. The point x=y=z=⅓ represents the so-called “white point” which defines the color white. High x-values represent reddish colors. High y-values represent greenish colors. High z-values represent bluish colors.

It is exemplary when the x-value in the CIE 1931 color space is at least 0.30 and at most 0.35, such as at least 0.31 and at most 0.32, at a sample thickness of 1 mm, 10 mm and/or 100 mm. It is exemplary when the y-value in the CIE 1931 color space is at least 0.30 and at most 0.35, such as at least 0.32 and at most 0.34, at a sample thickness of 1 mm, 10 mm and/or 100 mm. It is exemplary when the x-value and y-value are at least 0.30 and at most 0.35, such as at least 0.31 and at most 0.34, at a sample thickness of 1 mm, 10 mm and/or 100 mm.

Where reference is made to a “sample thickness” this refers to the thickness of the sample at which the respective parameters may be measured. The sample thickness does not relate to the actual thickness of the glass or of a glass article. The thickness of the glass or glass article is in no way limited to the sample thickness.

A particularly high color stability is present when the color coordinates undergo very little, if any, change as a result of irradiation. In the present application the color coordinates x₀, y₀ and z₀ describe the color coordinates of the unirradiated samples. The color coordinates x₁, y₁ and z₁ describe the color coordinates after 3 days of irradiation. The color coordinates x₂, y₂ and z₂ describe the color coordinates after 18 days of irradiation. Forming the ratios of the color coordinates (for example x₀/x₁ or x₁/x₂) makes it possible to show the color stability. The closer the individual ratios are to 1, the higher the color stability. Unless otherwise stated, the irradiation according to the invention is the irradiation of a sample (sample thickness in particular 100 mm) at a power density of 345 W/cm² with laser light having a wavelength of 455 nm.

For a sample thickness of 100 mm after irradiation at a power density of 345 W/cm² with laser light having a wavelength of 455 nm in the CIE standard valence system (CIE 1931) the ratio of the x-value x₁ after irradiation for 3 days to the x-value x₂ after irradiation for 18 days is in particular in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio x₁/x₂ may be, for example, at least 0.990, at least 0.992, at least 0.994, at least 0.996, at least 0.997, at least 0.998 or at least 0.999. The ratio x₁/x₂ may be, for example, at most 1.010, at most 1.008, at most 1.006, at most 1.004, at most 1.003, at most 1.002 or at most 1.001.

For a sample thickness of 100 mm irradiation at a power density of 345 W/cm² with laser light having a wavelength of 455 nm in the CIE standard valence system (CIE 1931) the ratio of the y-value y₁ after irradiation for 3 days to the y-value y₂ after irradiation for 18 days is in particular in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio y₁/y₂ may be, for example, at least 0.990, at least 0.992, at least 0.994, at least 0.996, at least 0.997, at least 0.998 or at least 0.999. The ratio y₁/y₂ may be, for example, at most 1.010, at most 1.008, at most 1.006, at most 1.004, at most 1.003, at most 1.002 or at most 1.001.

For a sample thickness of 100 mm irradiation at a power density of 345 W/cm² with laser light having a wavelength of 455 nm in the CIE standard valence system (CIE 1931) the ratio of the z-value z₁ after irradiation for 3 days to the z-value z₂ after irradiation for 18 days is in particular in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio z₁/z₂ may be, for example, at least 0.990, at least 0.992, at least 0.994, at least 0.996, at least 0.997, at least 0.998 or at least 0.999. The ratio z₁/z₂ may be, for example, at most 1.010, at most 1.008, at most 1.006, at most 1.004, at most 1.003, at most 1.002 or at most 1.001.

In some embodiments, the ratio x₁/x₂, the ratio y₁/y₂ and the ratio z₁/z₂ are in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio x₁/x₂, the ratio y₁/y₂ and the ratio z₁/z₂ may be, for example, at least 0.990, at least 0.992, at least 0.994, at least 0.996, at least 0.997, at least 0.998 or at least 0.999. The ratio x₁/x₂, the ratio y₁/y₂ and the ratio z₁/z₂ may be, for example, at most 1.010, at most 1.008, at most 1.006, at most 1.004, at most 1.003, at most 1.002 or at most 1.001.

For a sample thickness of 100 mm irradiation at a power density of 345 W/cm² with laser light having a wavelength of 455 nm in the CIE standard valence system (CIE 1931) the ratio of the x-value x₀ (without irradiation) to the x-value x₁ after irradiation for 3 days is in particular in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio x₀/x₁ may be, for example, at least 0.990, at least 0.992, at least 0.994, at least 0.996, at least 0.997, at least 0.998 or at least 0.999. The ratio x₀/x₁ may be, for example, at most 1.010, at most 1.008, at most 1.006, at most 1.004, at most 1.003, at most 1.002 or at most 1.001.

For a sample thickness of 100 mm irradiation at a power density of 345 W/cm² with laser light having a wavelength of 455 nm in the CIE standard valence system (CIE 1931) the ratio of the y-value y₀ (without irradiation) to the y-value y₁ after irradiation for 3 days is in particular in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio y₀/y₁ may be, for example, at least 0.990, at least 0.992, at least 0.994, at least 0.996, at least 0.997, at least 0.998 or at least 0.999. The ratio y₀/y₁ may be, for example, at most 1.010, at most 1.008, at most 1.006, at most 1.004, at most 1.003, at most 1.002 or at most 1.001.

For a sample thickness of 100 mm irradiation at a power density of 345 W/cm² with laser light having a wavelength of 455 nm in the CIE standard valence system (CIE 1931) the ratio of the z-value z₀ (without irradiation) to the z-value z₁ after irradiation for 3 days is in particular in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio z₀/z₁ may be, for example, at least 0.990, at least 0.992, at least 0.994, at least 0.996, at least 0.997, at least 0.998 or at least 0.999. The ratio z₀/z₁ may be, for example, at most 1.010, at most 1.008, at most 1.006, at most 1.004, at most 1.003, at most 1.002 or at most 1.001.

In some embodiments, the ratio x₀/x₁, the ratio y₀/y₁ and the ratio z₀/z₁ are in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio x₀/x₁, the ratio y₀/y₁ and the ratio z₀/z₁ may be, for example, at least 0.990, at least 0.992, at least 0.994, at least 0.996, at least 0.997, at least 0.998 or at least 0.999. The ratio x₀/x₁, the ratio y₀/y₁ and the ratio z₀/z₁ may be, for example, at most 1.010, at most 1.008, at most 1.006, at most 1.004, at most 1.003, at most 1.002 or at most 1.001.

In some embodiments, the ratio x₁/x₂, the ratio y₁/y₂, the ratio z₁/z₂, the ratio x₀/x₁, the ratio y₀/y₁ and the ratio z₀/z₁ are in a range from 0.990 to 1.010, from 0.992 to 1.008, from 0.994 to 1.006, from 0.996 to 1.004, from 0.997 to 1.003, from 0.998 to 1.002 or from 0.999 to 1.001. The ratio x₁/x₂, the ratio y₁/y₂, the ratio z₁/z₂, the ratio x₀/x₁, the ratio y₀/y₁ and the ratio z₀/z₁ may be, for example, at least 0.990, at least 0.992, at least 0.994, at least 0.996, at least 0.997, at least 0.998 or at least 0.999. The ratio x₁/x₂, the ratio y₁/y₂, the ratio z₁/z₂, the ratio x₀/x₁, the ratio y₀/y₁ and the ratio z₀/z₁ may be, for example, at most 1.010, at most 1.008, at most 1.006, at most 1.004, at most 1.003, at most 1.002 or at most 1.001.

In some embodiments, at least one of the following conditions is met:
(i) MnO₂ content is less than 1.0 ppm (by weight),
(ii) SnO₂ content is less than 0.1% by weight and Cl content is less than 0.05% by weight,
(iii) CeO₂ content is at least 0.005% by weight.

In some embodiments, at least two of the conditions are met. The glass may have, for example, an MnO₂ content of less than 1.0 ppm and an SnO₂ content of at least 0.1% by weight and a Cl content of at least 0.05% by weight. The glass may have, for example, an MnO₂ content of less than 1.0 ppm and a CeO₂ content of at least 0.005% by weight. The glass may have, for example, an SnO₂ content of less than 0.1% by weight and a Cl content of at least 0.05% by weight and a CeO₂ content of at least 0.005% by weight.

The glass may also have an MnO₂ content of less than 1.0 ppm and an SnO₂ content of at least 0.1% by weight, a Cl content of at least 0.05% by weight and a CeO₂ content of at least 0.005% by weight.

Raw materials for glass production are contaminated with MnO₂. It is therefore not possible to provide a glass not containing MnO₂ at all. However, contamination with MnO₂ can be reduced through selection of the raw materials. Commercial raw materials afford glasses having a proportion of MnO₂ which is in any event more than 1.0 ppm. Selection of particularly pure raw materials makes it possible to reduce the proportion of MnO₂ to values of less than 1.0 ppm. The proportion of MnO₂ may be at most 0.9 ppm, such as at most 0.8 ppm, at most 0.7 ppm, at most 0.6 ppm, at most 0.5 ppm, at most 0.4 ppm, at most 0.3 ppm, at most 0.2 ppm, at most 0.15 ppm, or at most 0.1 ppm. In some embodiments, the MnO₂ content is at least 0.01 ppm, at least 0.02 ppm or at least 0.05 ppm. The MnO₂ content of the glass may be, for example, in a range from 0.01 to <1.0 ppm, from 0.01 to 0.9 ppm, from 0.01 to 0.8 ppm, from 0.01 to 0.7 ppm, from 0.01 to 0.6 ppm, from 0.01 to 0.5 ppm, from 0.01 to 0.4 ppm, from 0.01 to 0.3 ppm, from 0.01 to 0.2 ppm, from 0.01 to 0.15 ppm, from 0.01 to 0.1 ppm, from 0.02 to <1.0 ppm, from 0.02 to 0.9 ppm, from 0.02 to 0.8 ppm, from 0.02 to 0.7 ppm, from 0.02 to 0.6 ppm, from 0.02 to 0.5 ppm, from 0.02 to 0.4 ppm, from 0.02 to 0.3 ppm, from 0.02 to 0.2 ppm, from 0.02 to 0.15 ppm, from 0.02 to 0.1 ppm, from 0.05 to <1.0 ppm, from 0.05 to 0.9 ppm, from 0.05 to 0.8 ppm, from 0.05 to 0.7 ppm, from 0.05 to 0.6 ppm, from 0.05 to 0.5 ppm, from 0.05 to 0.4 ppm, from 0.05 to 0.3 ppm, from 0.05 to 0.2 ppm, from 0.05 to 0.15 ppm, or from 0.05 to 0.1 ppm.

The SnO₂ content of the glass may be at least 0.1% by weight, such as at least 0.15% by weight, at least 0.2% by weight, at least 0.25% by weight, at least 0.3% by weight, at least 0.35% by weight, or at least 0.4% by weight. The Cl content of the glass may be at least 0.05% by weight, such as at least 0.1% by weight. The glass may have an SnO₂ content of at least 0.3% by weight and a Cl content of at least 0.05% by weight, such as an SnO₂ content of at least 0.4% by weight and a Cl content of at least 0.1% by weight. In some embodiments, the SnO₂ content is at most 1.0% by weight or at most 0.5% by weight and/or the Cl content is at most 1.0% by weight or at most 0.5% by weight. The SnO₂ content may be, for example, in a range from 0.1% to 1.0% by weight and/or the Cl content in a range from 0.05% by weight to 1.0% by weight. The SnO₂ content may be at most 1.0% by weight, for example at most 0.75% by weight, at most 0.5% by weight or at most 0.45% by weight. Very high SnO₂ contents can increase the crystallization propensity. The Cl content may be at most 1.0% by weight, for example at most 0.75% by weight, at most 0.5% by weight, at most 0.45% by weight or at most 0.4% by weight. Very high Cl contents can cause corrosion of the bath or destabilize the glass.

The ratio of the weight fraction of SnO₂ the weight fraction of Cl may be in a range from 1:5 to 5:1, for example from 1:4 to 4:1, from 1:3 to 3:1, from 1:2 to 2:1 or from 1:1.5 bis 1.5:1. In some embodiments, the proportion of SnO₂ is smaller than the proportion of Cl.

CeO₂ does undesirably result in an increase in the Exto values. However, it has been found that, surprisingly, small proportions of CeO₂ can improve solarization resistance in such a way that the reduction in the Ext₁ values overcompensates the increase in the Ext₀ values. The CeO₂ content may be at least 0.005% by weight, such as at least 0.01% by weight. The CeO₂ content may be at most 0.05% by weight or at most 0.04% by weight. The CeO₂ content may be in the range from 0.005% by weight to 0.05% by weight, for example from 0.01% by weight to 0.04% by weight.

The glass provided according to the invention may contain less than 0.3% by weight, such as at most 0.2% by weight, or at most 0.1% by weight, of each of the components Al₂O₃, Li₂O, MgO, ZnO, SrO, ZrO₂, La₂O₃, P₂O₅ and As₂O₃ or may be even free from these components. Especially in embodiments in which the glass contains CeO₂ in a proportion of at least 0.005% by weight or at least 0.01% by weight the glass may contain less than 0.3% by weight, such as at most 0.2% by weight or at most 0.1% by weight, of TiO₂ or may even be free from TiO₂.

The glass may contain SiO₂ in a proportion of 52.5% to 77.5% by weight, such as of 55% to 75% by weight, or of 57.5% to 72.5% by weight. The SiO₂ content may be, for example, at least 52.5% by weight, at least 55% by weight or at least 57.5% by weight. The SiO₂ content may be, for example, at most 77.5% by weight, at most 75% by weight or at most 72.5% by weight.

The glass may contain B₂O₃ in a proportion of 5% to 25% by weight, such as of 7.5% to 20% by weight, or of 9% to 19% by weight. The B₂O₃ content may be, for example, at least 5% by weight, at least 7.5% by weight or at least 9% by weight. The B₂O₃ content may be, for example, at most 25% by weight, at most 20% by weight or at most 19% by weight.

The glass may contain Na₂O in a proportion of 0% to 17.5% by weight, for example of 0% to 15% by weight, or of 0% to 12.5% by weight. In some embodiments, the glass contains at least 2% by weight, at least 5% by weight or even at least 8% by weight of Na₂O. The Na₂O content may be, for example, at most 17.5% by weight, at most 15% by weight or at most 12.5% by weight.

The glass may contain K₂O in a proportion of 2% to 24% by weight, such as of 4% to 23% by weight or of 6% to 22% by weight. The K₂O content may be, for example, at least 2% by weight, at least 4% by weight or at least 6% by weight. The K₂O content may be, for example, at most 24% by weight, at most 23% by weight or at most 22% by weight.

The sum of the proportions of alkali metal oxides (R₂O) in the glass is in a range from 5% to 30% by weight, such as from 10% to 25% by weight or from 15% to 22% by weight. The R₂O content may be, for example, at least 5% by weight, at least 10% by weight or at least 15% by weight. The R₂O content may be, for example, at most 30% by weight, at most 25% by weight or at most 22% by weight. The glass may contain no further alkali metal oxides in addition to Na₂O and/or K₂O.

The glass may contain CaO in a proportion of 0% to 5% by weight, such as of 0% to 2% by weight or of 0% to 1% by weight. In some embodiments, the glass contains at least 0.1% by weight or at least 0.2% by weight of CaO. The CaO content may be, for example, at most 5% by weight, at most 2% by weight or at most 1% by weight.

The glass may contain BaO in a proportion of 0% to 5% by weight, such as of 0% to 3.5% by weight or of 0% to 2% by weight. In some embodiments, the glass contains at least 0.1% by weight of BaO. The BaO content may be, for example, at most 5% by weight, at most 3.5% by weight or at most 2% by weight.

The glass may contain TiO₂ in a proportion of 0% to 2% by weight, such as of 0% to 1% by weight or of 0% to 0.5% by weight. In some embodiments, the glass contains at least 0.1% by weight of TiO₂. The TiO₂ content may be, for example, at most 2% by weight, at most 1% by weight or at most 0.5% by weight.

The glass may contain F in a proportion of 0% to 15% by weight, such as of 0% to 12.5% by weight or of 0% to 10% by weight. In some embodiments, the glass contains at least 1% by weight, at least 2% by weight or even at least 5% by weight of F. The F content may be, for example, at most 15% by weight, at most 12.5% by weight, or at most 10% by weight.

The glass may contain Sb₂O₃ in a proportion of 0.01% to 0.45% by weight, such as of 0.01% to 0.4% by weight or of 0.01% to 0.35% by weight.

The glass provided according to the invention may be a borosilicate glass.

An exemplary glass provided according to the invention comprises the following components in the specified proportions (in % by weight).

| | from | to |
|---|---|---|
| SiO₂ | 50 | 80 |
| B₂O₃ | 2 | 30 |
| Al₂O₃ | 0 | 5 |
| Li₂O | 0 | 5 |
| Na₂O | 0 | 20 |
| K₂O | 1 | 25 |
| MgO | 0 | 5 |
| CaO | 0 | 10 |
| BaO | 0 | 10 |
| ZnO | 0 | 5 |
| SrO | 0 | 5 |
| TiO₂ | 0 | 5 |
| ZrO₂ | 0 | 5 |
| La₂O₃ | 0 | 5 |
| P₂O₅ | 0 | 5 |
| F | 0 | 20 |
| Sb₂O₃ | 0 | 0.5 |
| As₂O₃ | 0 | <0.3 |
| SnO₂ | 0 | 0.5 |
| Σ R₂O | 5 | 30 |

The present invention further relates to a beam guiding element comprising or consisting of a glass provided according to the invention.

The present invention further relates to an imaging system comprising
a) at least one laser light source B having a wavelength λ_{B} in the spectral range from 380 nm to 490 nm and
b) a beam guiding element comprising or consisting of a glass provided according to the invention,
   wherein the laser light source B is suitable for generating at at least one point of the beam guiding element an average surface power density of more than 10 W/cm².

The present invention further relates to an imaging system comprising
a) at least one laser light source B having the wavelength λ_{B} in the spectral range from 380 nm to 490 nm, at least one laser light source G having a wavelength λ_{G} in the spectral range from >490 nm to 585 nm and at least one laser light source R having a wavelength λ_{R} in the spectral range from >585 nm to 750 nm and
b) a beam guiding element,
   wherein the laser light source B, the laser light source G and the laser light source R are suitable for generating at at least one point of the beam guiding element an average surface power density of more than 10 W/cm² and the beam guiding element consists of a glass provided according to the invention or comprises a glass provided according to the invention.

The present invention further relates to the use of an imaging system, beam guiding element and/or glass provided according to the invention in particular in a projector or in material processing.

The invention further relates to a projector comprising an imaging system, beam guiding element and/or glass provided according to the invention, in particular a DLP projector.

### EXAMPLES

Samples of the example glasses having a thickness of 100 mm were each irradiated at a power density of 345 W/cm²for the specified duration with laser light having a wavelength of 455 nm. In order to achieve not only a high power density but also a homogeneous sample irradiation, the sample was polished on all sides prior to irradiation and the laser light irradiated onto the 4×4 mm² entry surface at the angle of total internal reflection (TIR). Using a 55 W laser this achieved an irradiation at a power density of 345 W/cm². The power density in the volume was about 331 W/cm².

The sample size was 100 mm×4 mm×4 mm.

The composition of the glasses is shown in Table 1 which follows (in % by weight)

TABLE 1

| | | | | | Comp. |
|---|---|---|---|---|---|
| | Ex. 1 | Ex. 2 | Ex. 3 | Ex. 4 | ex. A |
| SiO₂ | 70 | 70 | 70 | 70 | 70 |
| B₂O₃ | 11 | 11 | 11 | 11 | 11 |
| Li₂O | | | | | |
| Na₂O | 10 | 10 | 10 | 10 | 10 |
| K₂O | 7 | 7 | 7 | 7 | 7 |
| CaO | 0.2 | 0.2 | 0.2 | 0.2 | 0.2 |
| BaO | 1 | 1 | 1 | 1 | 1 |
| ZnO | | | | | |
| TiO₂ | 0.1 | | | 0.05 | 0.1 |
| ZrO₂ | | | | | |
| La₂O₃ | | | | | |
| F | | | | | |
| Sb₂O₃ | 0.3 | | | 0.3 | 0.3 |
| SnO₂ | | 0.3 | 0.3 | | |
| Cl | 0.34 | 0.35 | 0.34 | 0.34 | 0.33 |
| CeO₂ | | 0.01 | | 0.01 | |
| MnO₂ | 0.1 ppm | 0.1 ppm | 0.1 ppm | 0.1 ppm | 1.1 ppm |

For comparative example A, the MnO₂ content was 1.1 ppm (on a weight basis). For example glasses 1 to 4, the MnO₂ content was 0.1 ppm in each case (on a weight basis).

The first solarization component was MnO₂. The second solarization component was either Sb₂O₃ or SnO₂. The molar proportion of SnO₂ in examples 2 and 3 and twice the molar proportion of Sb₂O₃ in examples 1 and 4 (and in comparative example A) are in each case about 0.13 mol % (1300 ppm on a molar basis).

The average standard redox potential E⁰ (at pH 14) of the second solarization component in examples 2 and 3 is equal to the standard redox potential of the redox pair Sn²⁺/Sn⁴⁺ (at pH 14) and is −0.9 V.

The average standard redox potential E⁰ (at pH 14) of the second solarization component in examples 1 and 4 (and comparative example A) is equal to the standard redox potential of the redox pair Sb³⁺/Sb⁵⁺ (at pH 14) and is −0.6 V.

The product of the average standard redox potential E⁰ of the second solarization component and the sum of the molar proportion of the first metal oxide M^{I}O₂ and twice the molar proportion of the second metal oxide M^{II}₂O₃ in the glass is −1170 V*ppm for example glasses 2 and 3 (1300 ppm multiplied by −0.9 V) and −780 V*ppm for glasses 1 and 4 and comparative example A (1300 ppm multiplied by −0.6 V).

### Color Stability

To determine color stability, the color coordinates (x, y, z) in the CIE standard valence system (CIE 1931) without irradiation and after 3 days of irradiation and after 18 days of radiation at a power density of 345 W/cm² with laser light having a wavelength of 455 nm were determined and compared. The results are shown in Table 2 for example glasses 1 and 3. The color coordinates x₀, y₀ and z₀ describe the color coordinates of the unirradiated samples. The color coordinates x₁, y₁ and z₁ describe the color coordinates after 3 days of irradiation. The color coordinates x₂, y₂ and z₂ describe the color coordinates after 18 days of irradiation. Forming the ratios of the color coordinates (for example x₀/x₁ or x₁/x₂) makes it possible to show the color stability. The closer the individual ratios are to 1, the higher the color stability.

TABLE 2

| Coordinate | Example | Example |
|---|---|---|
| ratio | glass 1 | glass 3 |
| x₀/x₁ | 0.999 | 0.998 |
| y₀/y₁ | 0.994 | 0.999 |
| z₀/z₁ | 1.006 | 1.002 |
| x₁/x₂ | 0.996 | 1.000 |
| y₁/y₂ | 0.994 | 1.000 |
| z₁/z₂ | 1.009 | 1.000 |

The color coordinate ratios are very close to 1 both for example glass 1 and for example glass 3. The glasses thus have a very high color stability.

A particular advantage of example glass 3 compared to example glass 1 becomes apparent when considering the color-coordinate ratios obtained as a quotient after 18 days of irradiation and after 3 days of irradiation (x₁/x₂, y₁/y₂ and z₁/z₂). In the case of example glass 3 no change occurs even up to the third decimal place of the ratio despite the sample having been irradiated at high power density for a duration of 15 days (18 days minus 3 days). In other words, the color coordinates after 3 days of irradiation substantially correspond to the color coordinates after 18 days of irradiation. This applies not only to the x-coordinates but also to the y-coordinates and the z-coordinates. Example glass 3 exhibits extraordinary color stability.

### Long-Term Solarization Resistance

Long-term solarization resistance was determined by determining the additional extinction Ext₁(436 nm) relative to Ext₀(436 nm) of a sample having a thickness of 100 mm at a wavelength of 436 nm after irradiation at a power density of 345 W/cm² for 40 days with laser light having a wavelength of 455 nm, wherein Ext₀ is the extinction at a wavelength of 436 nm of a sample having a thickness of 100 mm without corresponding irradiation. The results are shown in the sole figure.

The very good long-term solarization stability of example glasses 1 to 4 provided according to the invention is apparent. By contrast, comparative example A exhibits a high induced extinction even after a relatively short irradiation.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A glass, comprising the following components in the specified proportions (in % by weight):

| | from | to |
|---|---|---|
| SiO₂ | 50 | 80; |
| B₂O₃ | 2 | 30; |
| Al₂O₃ | 0 | 5; |
| CaO | 0 | 10; |
| BaO | 0 | 10; |
| Li₂O | 0 | 5; |
| Na₂O | 0 | 20; |
| K₂O | 1 | 25; |
| Σ R₂O | 5 | 30; |

wherein R₂O comprises at least one alkali metal oxide, the glass comprises at least one first solarization component and at least one second solarization component, wherein a proportion of the first solarization component in the glass is in a range from 0.01 to <1.0 ppm (by weight) and wherein a proportion of the second solarization component in the glass is in a range from 1000 to 10,000 ppm (by weight).

2. The glass of claim 1, wherein the first solarization component is MnO₂.

3. The glass of claim 1, wherein the second solarization component comprises a first metal oxide M^{I}O₂, a second metal oxide M^{II}₂O₃, or a combination thereof.

4. The glass of claim 3, wherein an average standard redox potential E⁰ of the second solarization component is an average of a proportionally weighted standard redox potential of the redox pair M^{I2+}/M^{I4+} and a proportionally weighted standard redox potential of the redox pair M^{II3+}/M^{II5+}, wherein the proportionally weighted standard redox potential of the redox pair M^{I2+}/M^{I4+} is the product of the standard redox potential of the redox pair M^{I2+}/M^{I4+} and a molar proportion of the first metal oxide M^{I}O₂ in the second solarization component, wherein the proportionally weighted standard redox potential of the redox pair M^{II3+}/M^{II5+} is the product of the standard redox potential of the redox pair M^{II3+}/M^{II5+} and twice a molar proportion of the second metal oxide M^{II}₂O₃ in the second solarization component, and wherein the average standard redox potential E⁰ of the second solarization component is at most −50 mV.

5. The glass of claim 3, wherein at least one of the following is satisfied:
the product of an average standard redox potential E⁰ of the second solarization component and the sum of a molar proportion of the first metal oxide M^{I}O₂ and twice a molar proportion of the second metal oxide M^{II}₂O₃ in the glass is at most −100 V*ppm; or
the product of the average standard redox potential E⁰ of the second solarization component and a ratio of the molar proportion of the second solarization component to the molar proportion of the first solarization component is at most −5000 V.

6. The glass of claim 1, wherein a weight ratio of the proportion of the second solarization component to the proportion of the first solarization component is in the range from 2*10³:1 to 1*10⁵:1.

7. The glass of claim 1, wherein the second solarization component is selected from the group consisting of SnO₂, Sb₂O₃ and combinations thereof.

8. The glass of claim 1, wherein for a sample thickness of 100 mm after irradiation at a power density of 345 W/cm² with laser light having a wavelength of 455 nm in the CIE standard valence system (CIE 1931) a ratio of an x-value x₁ after irradiation for 3 days to an x-value x₂ after irradiation for 18 days is in a range from 0.990 to 1.010.

9. The glass of claim 1, wherein an additional extinction Ext₁(436 nm) relative to Ext₀(436 nm) at a wavelength of 436 nm of a sample having a thickness of 100 mm after irradiation at a power density of 345 W/cm² for 40 days with laser light having a wavelength of 455 nm is at most 0.01/cm, wherein Ext₀(436 nm) is the extinction at a wavelength of 436 nm of a sample having a thickness of 100 mm without corresponding irradiation, wherein an additional extinction Ext₁(546 nm) relative to Ext₀(546 nm) at a wavelength of 546 nm of a sample having a thickness of 100 mm after irradiation at a power density of 345 W/cm² for 40 days with laser light having a wavelength of 455 nm is at most 0.01/cm, wherein Ext₀(546 nm) is the extinction at a wavelength of 546 nm of a sample having a thickness of 100 mm without corresponding irradiation, and wherein an additional extinction Ext₁(644 nm) relative to Ext₀(644 nm) at a wavelength of 644 nm of a sample having a thickness of 100 mm after irradiation at a power density of 345 W/cm² for 40 days with laser light having a wavelength of 455 nm is at most 0.01/cm, wherein Ext₀(644 nm) is the extinction at a wavelength of 644 nm of a sample having a thickness of 100 mm without corresponding irradiation.

10. A beam guiding element, comprising or consisting of:
a glass comprising the following components in the specified proportions (in % by weight):

| | from | to |
|---|---|---|
| SiO₂ | 50 | 80; |
| B₂O₃ | 2 | 30; |
| Al₂O₃ | 0 | 5; |
| CaO | 0 | 10; |
| BaO | 0 | 10; |
| Li₂O | 0 | 5; |
| Na₂O | 0 | 20; |
| K₂O | 1 | 25; |
| Σ R₂O | 5 | 30; |

wherein R₂O comprises at least one alkali metal oxide, wherein the glass comprises at least one first solarization component and at least one second solarization component, wherein a proportion of the first solarization component in the glass is in a range from 0.01 to <1.0 ppm (by weight) and wherein a proportion of the second solarization component in the glass is in a range from 1000 to 10,000 ppm (by weight).

11. The beam guiding element of claim 10, wherein the first solarization component is MnO₂.

12. The beam guiding element of claim 10, wherein the second solarization component comprises a first metal oxide M^{I}O₂, a second metal oxide M^{II}₂O₃, or a combination thereof.

13. The beam guiding element of claim 12, wherein an average standard redox potential E⁰ of the second solarization component is an average of a proportionally weighted standard redox potential of the redox pair M^{I2+}/M^{I4+} and a proportionally weighted standard redox potential of the redox pair M^{II3+}/M^{II5+}, wherein the proportionally weighted standard redox potential of the redox pair M^{I2+}/M^{I4+} is the product of the standard redox potential of the redox pair M^{I2+}/M^{I4+} and a molar proportion of the first metal oxide M^{I}O₂ in the second solarization component, wherein the proportionally weighted standard redox potential of the redox pair M^{II3+}/M^{II5+} is the product of the standard redox potential of the redox pair M^{II3+}/M^{II5+} and twice a molar proportion of the second metal oxide M^{II}₂O₃ in the second solarization component, and wherein the average standard redox potential E⁰ of the second solarization component is at most −50 mV.

14. The beam guiding element of claim 12, wherein at least one of the following is satisfied:
the product of an average standard redox potential E⁰ of the second solarization component and the sum of a molar proportion of the first metal oxide M^{I}O₂ and twice a molar proportion of the second metal oxide M^{II}₂O₃ in the glass is at most −100 V*ppm; or
the product of the average standard redox potential E⁰ of the second solarization component and a ratio of the molar proportion of the second solarization component to the molar proportion of the first solarization component is at most −5000 V.

15. The beam guiding element of claim 10, wherein a weight ratio of the proportion of the second solarization component to the proportion of the first solarization component is in the range from 2*10³:1 to 1*10⁵:1.

16. The beam guiding element of claim 10, wherein the second solarization component is selected from the group consisting of SnO₂, Sb₂O₃ and combinations thereof.

17. An imaging system, comprising:
at least one laser light source having a wavelength in a spectral range from 380 nm to 490 nm; and
a beam guiding element comprising a glass comprising the following components in the specified proportions (in % by weight):

| | from | to |
|---|---|---|
| SiO₂ | 50 | 80; |
| B₂O₃ | 2 | 30; |
| Al₂O₃ | 0 | 5; |
| CaO | 0 | 10; |
| BaO | 0 | 10; |
| Li₂O | 0 | 5; |
| Na₂O | 0 | 20; |
| K₂O | 1 | 25; |
| Σ R₂O | 5 | 30; |

wherein R₂O comprises at least one alkali metal oxide, wherein the glass comprises at least one first solarization component and at least one second solarization component, wherein a proportion of the first solarization component in the glass is in a range from 0.01 to <1.0 ppm (by weight) and wherein a proportion of the second solarization component in the glass is in a range from 1000 to 10,000 ppm (by weight), wherein the at least one laser light source is suitable for generating at at least one point of the beam guiding element an average surface power density of more than 10 W/cm².

18. The imaging system of claim 17, wherein the first solarization component is MnO₂.

19. The imaging system of claim 17, wherein the second solarization component comprises a first metal oxide M^{I}O₂, a second metal oxide M^{II}₂O₃, or a combination thereof.

20. The imaging system of claim 19, wherein an average standard redox potential E⁰ of the second solarization component is an average of a proportionally weighted standard redox potential of the redox pair M^{I2+}/M^{I4+} and a proportionally weighted standard redox potential of the redox pair M^{II3+}/M^{II5+}, wherein the proportionally weighted standard redox potential of the redox pair M^{I2+}/M^{I4+} is the product of the standard redox potential of the redox pair M^{I2+}/M^{I4+} and a molar proportion of the first metal oxide M^{I}O₂ in the second solarization component, wherein the proportionally weighted standard redox potential of the redox pair M^{II3+}/M^{II5+} is the product of the standard redox potential of the redox pair M^{II3+}/M^{II5+} and twice a molar proportion of the second metal oxide M^{II}₂O₃ in the second solarization component, and wherein the average standard redox potential E⁰ of the second solarization component is at most −50 mV.
